(19) United States
(12) Patent Application Publication
(10) Pub. No.: US 2018/0282938 A1
(43) Pub. Date: Oct. 4, 2018

(54) POST-COATING COMPOSITION FOR REINFORCEMENT FIBERS

(71) Applicant: OCV Intellectual Capital, LLC, Toledo, OH (US)

(72) Inventors: David Hartman, Granville, OH (US); Christian Espinoza Santos, Columbus, OH (US); David L. Molnar, Newark, OH (US)

(21) Appl. No.: 15/765,758

(22) PCT Filed: Oct. 7, 2016
(86) PCT No.: PCT/US16/55936

§ 371 Date: Apr. 4, 2018

Related U.S. Application Data
(60) Provisional application No. 62/238,757, filed on Oct. 8, 2015.

(51) Int. Cl. D06M 15/263; D06M 15/356; D06M 15/564; D06M 13/11; D06M 13/123; D06M 13/46; D06M 13/513; D06M 11/46; C09D 131/04; C09D 139/06; C09D 175/04

(52) U.S. Cl. CPC D06M 15/263; D06M 15/3562; D06M 15/564; D06M 13/11; D06M 13/123; D06M 2101/20; D06M 13/513; D06M 11/46; C09D 131/04; C09D 139/06; C09D 175/04; D06M 13/46

(57) ABSTRACT

An aqueous post-coat composition for coating a fiber tow is disclosed. The aqueous composition includes about 0.5 to about 5.0 wt. % solids of a film former and about 0.05 to about 2.0 wt. % solids of a compatibilizer. The compatibilizer may be at least one of a silicone-based coupling agent, a titanate coupling agent, a zirconate coupling agent, gluteric dialdehyde, and a quaternary ammonium antistatic agent.

### BACKGROUND

Fiber reinforced composite materials consist of fibers embedded in or bonded to a matrix material with distinct interfaces between the materials. Generally, the fibers are the load-carrying members, while the surrounding matrix keeps the fibers in the desired location and orientation, acts as a load transfer medium, and protects the fibers from environmental damage. Common types of fibers in commercial use today include various types of glass, carbon, and synthetic fibers.

It is well known that the interface between the fibers and the matrix material plays a key role in determining various mechanical properties of composites. The efficiency of the stress transfer between the fibers and the matrix material is determined in large part by the molecular interaction at the interface. An effective way of controlling composite properties is by fiber surface treatment using sizing compositions. For instance, the use of silane coupling agents in sizing compositions applied to glass fibers is known to improve the interfacial adhesion at the interface between the glass fibers and the matrix resin, At the interface between the glass fibers and the silane coupling agent, the hydroxyl groups of the silanes are reactive with the inorganic glass fibers to form a chemical bond with the surface of the glass fibers, while the other reactive groups (e.g., vinyl, epoxy, methacryl, amino, and mercapto groups) are reactive with various kinds of organic resins to form a chemical bond.

However, carbon fibers present processing difficulties in many applications, which may lead to slower product manufacturing. Carbon fibers can be brittle and have low abrasion resistance and thus readily generate fuzz or broken threads during downstream processing. Additionally, due at least in part to their hydrophobic nature, carbon fibers do not interface or wet (i.e., take and hold an aqueous coating) as easily as other reinforcement fibers, such as glass fibers, in traditional resin matrices. Wetting refers to the ability of the resin to bond to and uniformly spread over the fiber surface.

Prior attempts to improve wetting of carbon fibers have involved exposing carbon fibers to an oxidative surface treatment and subsequently applying a sizing composition to the fibers. For instance, U.S. Pat. No. 3,957,716 discloses coating carbon fibers with a sizing composition including an epoxy compound, selected from a group consisting of polyglycidyl ethers, cycloaliphatic polyepoxides, and mixtures thereof.

However, although such sizing compositions may help improve the processing of carbon fibers compared to non-sized carbon fibers, sizing compositions alone have yet to overcome compatibility issues with many resin systems like unsaturated polyester or polyamide.

### SUMMARY

In accordance with various aspects of the general inventive concepts, a post-coat composition for coating a fiber tow is disclosed. The post-coat composition includes about 0.5 to about 5.0 wt. % (including any and all weight percentages between these endpoints) solids of a film former comprising one or more of polyvinylpyrrolidone, polyvinylacetate, and polyurethane; about 0.05 to about 5.0 wt. % (including any and all weight percentages between these endpoints) solids of a compatibilizer; and water. The compatibilizer may include a silicone-based coupling agent, such as one or more of aminopropyltriethoxysilane (A-1100), methyl-trimethoxysilane (A-163), and γ-methacryloxypropyltrimethoxysilane (A-174), a titanate coupling agent, a zirconate coupling agent, organic dialdehyde, and a quaternary ammonium antistatic agent.

In some exemplary embodiments, the fiber comprises at least one of glass, carbon, aramid, polyesters, polyolefins, polyamides, silicon carbide (SiC), and boron nitride fibers. In some exemplary embodiments, the fiber is a carbon fiber bundle comprising no greater than 12,000 filaments, or between about 1,000 and about 6,000 filaments, or between about 2,000 and about 3,000 filaments.

In some exemplary embodiments, the film former consists of polyvinylpyrrolidone. The polyvinylpyrrolidone may have a molecular weight of 1,000,000 to 1,700,000.

In some exemplary embodiments, the silicone-based coupling agent comprises at least one of γ-aminopropyltriethoxysilane (A-1100), n-trimethoxy-silyl-propyl-ethylene-diamine (A-1120), γ-methacryloxypropyltrimethoxysilane (A-174), γ-glycidoxypropyltrimethoxysilane (A-187), methyl-trichlorosilane (A-154), methyl-trimethoxysilane (A-163), γ-mercaptopropyl-trimethoxy-silane: (A-189), bis-(3-[triethoxysilyl]propyl)tetrasulfane (A-1289), γ-chloropropyl-trimethoxy-silane (A-143), vinyl-triethoxy-silane (A-151), vinyl-tris-(2-methoxyethoxy)silane (A-172), vinylmethyldimethoxysilane (A-2171), vinyl-triacetoxy silane (A-188), octyltriethoxysilane (A-137), and methyltriethoxysilane (A-162). In some exemplary embodiments, the silicone-based coupling agent is a mixture of aminopropyltriethoxysilane (A-1100) and at least one of methyl-trimethoxysilane (A-163) and γ-methacryloxypropyltrimethoxysilane (A-174). In some exemplary embodiments, the silicone-based coupling agent comprises aminopropyltriethoxysilane (A-1100) and methyl-trimethoxysilane (A-163) in a ratio of 1:1 to 3:1. In some exemplary embodiments, silicone-based coupling agent comprises aminopropyltriethoxysilane (A-1100) and γ-methacryloxypropyltrimethoxysilane (A-174) in a ratio of 1:1 to 3:1. In some exemplary embodiments, film former comprises polyvinylpyrrolidone and wherein said compatibilizer comprises aminopropyltriethoxysilane (A-1100) and methyl-trimethoxysilane (A-163) in a ratio of 1:1 to 3:1 and triethylalkyletherammonium sulfate.

In some exemplary embodiments, the film former comprises polyvinylpyrrolidone and wherein said compatibilizer comprises aminopropyltriethoxysilane (A-1100) and γ-methacryloxypropyltrimethoxysilane (A-174) in a ratio of 1:1 to 3:1 and triethylalkyletherammonium sulfate.

In accordance with various aspects of the general inventive concepts, a composition for coating a fiber is disclosed. The composition includes a film former comprising at least one of polyvinylpyrrolidone, polyvinylacetate, and polyurethane; a compatibilizer comprising at least one of a silicone-based coupling agent, a titanate coupling agent, a zirconate coupling agent, gluteric dialdehyde, and a quaternary ammonium antistatic agent; and water.

In some exemplary embodiments, the fiber comprises at least one of glass, carbon, aramid, polyesters, polyolefins, polyamides, silicon carbide (SiC), and boron nitride fibers.

In some exemplary embodiments, the fiber is a carbon fiber bundle comprising no greater than 12,000 filaments, or between about 1,000 and about 6,000 filaments, or between about 2,000 and about 3,000 filaments.

In accordance with various aspects of the general inventive concepts, a process for compatibilizing a plurality of reinforcement fibers with a polymer matrix material is disclosed. The process comprises the steps of coating the reinforcement fibers with a coating composition comprising about 0.5 to about 5.0 wt. % (including any and all weight percentages between these endpoints) solids of a film former comprising at least one of polyvinylpyrrolidone, polyvinylacetate, and polyurethane; about 0.05 to about 2.0 wt. % (including any and all weight percentages between these endpoints) solids of a compatibilizer comprising at least one of a silicone-based coupling agent, a titanate coupling agent, a zirconate coupling agent, organic dialdehyde, and a quaternary ammonium antistatic agent; and water.

In some exemplary embodiments, the reinforcement fibers comprise at least one of glass, carbon, aramid, polyesters, polyolefins, polyamides, silicon carbide (SiC), and boron nitride fibers. In some exemplary embodiments, prior to coating the reinforcement fibers with said coating composition, the reinforcement fibers are coated with a sizing composition and the sizing composition is dried. In some exemplary embodiments, the sizing composition comprises at least one of an epoxy, vinyl ester, and urethane film former.

In some exemplary embodiments, the film former comprises polyvinylpyrrolidone. In some exemplary embodiments, the silicone-based coupling agent comprises at least one of γ-aminopropyltriethoxysilane (A-1100), n-trimethoxy-silyl-propyl-ethylene-diamine (A-1120), γ-methacryloxypropyltrimethoxysilane (A-174), γ-glycidoxypropyltrimethoxysilane (A-187), methyl-trichlorosilane (ArI 54), methyl-trimethoxysilane (A-163), γ-mercaptopropyl-trimethoxy-silane: (A-189), bis-(3-[triethoxysilyl]propyl)tetrasulfane (A-1289), γ-chloropropyl-trimethoxy-silane (A-143), vinyl-triethoxy-silane (A-151), vinyl-tris-(2-methoxyethoxy)silane (A-172), vinylmethyldimethoxysilane (A-2171), vinyl-triacetoxy silane (A-188), octyltriethoxysilane (A-137), and methyltriethoxysilane (A-162). In some exemplary embodiments, the silicone-based coupling agent is a mixture of aminopropyltriethoxysilane (A-1100) and at least one of methyl-trimethoxysilane (A-163) and γ-methacryloxypropyltrimethoxysilane (A-174). In some exemplary embodiments, the silicone-based coupling agent comprises aminopropyltriethoxysilane (A-1100) and methyl-trimethoxysilane (A-163) in a ratio of 1:1 to 3:1. In some exemplary embodiments the silicone-based coupling agent comprises aminopropyltriethoxysilane (A-1100) and γ-methacryloxypropyltrimethoxysilane (A-174) in a ratio of 1:1 to 3:1.

In some exemplary embodiments, the quaternary ammonium antistatic agent comprises triethylalkyletherammonium sulfate.

In some exemplary embodiments, the organic dialdehyde comprises one or more of gluteric dialdehyde, glycoxal, malondialdehyde, succidialdehyde, and phthaladldehyde. In some exemplary embodiments, the organic dialdehyde comprises gluteric dialdehyde.

In accordance with various aspects of the general inventive concepts, a carbon fiber coated with a composition is disclosed. The composition comprises about 0.5 to about 5.0 wt. % (including any and all weight percentages between these endpoints) solids of a film limner comprising at least one of polyvinylpyrrolidone, polyvinylacetate, and polyurethane; about 0.05 to about 2.0 wt. % (including any and all weight percentages between these endpoints) solids of a compatibilizer comprising at least one of a silicone-based coupling agent, a titanate coupling agent, a zirconate coupling agent, gluteric dialdehyde, and a quaternary ammonium antistatic agent; and water, wherein the carbon fiber comprises less than about 12,000 filaments.

In some exemplary embodiments, the carbon fiber comprises less than about 10,000 filaments, or less than about 8,000 filaments, or less than about 6,000 filaments, or less than about 4,000 filaments, or less than about 2,000 filaments, or from about 2,000 to about 3,000 filaments. In some exemplary embodiments, the carbon fiber has a width of between about 0.5 mm to about 4.0 mm.

In some exemplary embodiments, the carbon fiber has been coated with a sizing composition comprising at least one of an epoxy, vinyl ester, and urethane film former.

Various exemplary embodiments of the general inventive concepts are further directed to a fiber-reinforced composite comprising a plurality of reinforcement fibers having a coating thereon. The coating comprises about 0.5 to about 5.0 wt. % (including any and all weight percentages between these endpoints) solids of a film former comprising at least one of polyvinylpyrrolidone, polyvinylacetate, and polyurethane; about 0.05 to about 2.0 wt. % (including any and all weight percentages between these endpoints) solids of a compatibilizer comprising at least one of a silicone-based coupling agent, a titanate coupling agent, a zirconate coupling agent, organic dialdehyde, and a quaternary ammonium antistatic agent; and water. The fiber-reinforced composite further includes a polymer resin material.

In some exemplary embodiments, the reinforcement fibers comprise at least one of glass, carbon, aramid, polyesters, polyolefins, polyamides, silicon carbide (SiC), and boron nitride fibers. In some exemplary embodiments, the film former comprises polyvinylpyrrolidone. In some exemplary embodiments, the polyvinylpyrrolidone has a molecular weight of 1,000,000 to 1,700,000.

In some exemplary embodiments, the silicone-based coupling agent comprises at least one of γ-aminopropyltriethoxysilane (A-1100), n-trimethoxy-silyl-propyl-ethylene-diamine (A-1120), γ-methacryloxypropyltrimethoxysilane (A-174), γ-glycidoxypropyltrimethoxysilane (A-187), methyl-trichlorosilane (An 54), methyl-trimethoxysilane (A-163), γ-mercaptopropyl-trimethoxy-silane: (A-189), bis-(3-[triethoxysilyl]propyl)tetrasulfane (A-1289), γ-chloropropyl-trimethoxy-silane (A-143), vinyl-triethoxy-silane (A-151), vinyl-tris-(2-methoxyethoxy)silane (A-172), vinylmethyldimethoxysilane (A-2171), vinyl-triacetoxy silane (A-188), octyltriethoxysilane (A-137), and methyltriethoxysilane (A-162).

In some exemplary embodiments, the silicone-based coupling agent is a mixture of aminopropyltriethoxysilane (A-1100) and at least one of methyl-trimethoxysilane (A-163) and γ-methacryloxypropyltrimethoxysilane (A-174). In some exemplary embodiments, the silicone-based coupling agent comprises aminopropyltriethoxysilane (A-1100) and methyl-trimethoxysilane (A-163) in a ratio of 1:1 to 3:1. In some exemplary embodiments, the silicone-based coupling agent comprises aminopropyltriethoxysilane (A-1100) and γ-methacryloxypropyltrimethoxysilane (A-174) in a ratio of 1:1 to 3:1.

In some exemplary embodiments, the quaternary ammonium antistatic agent comprises triethylalkyletherammonium sulfate.

In some exemplary embodiments, the organic dialdehyde comprises one or more of gluteric dialdehyde, glycoxal, malondialdehyde, succidialdehyde, and phthaladldehyde. In some exemplary embodiments, the organic dialdehyde comprises gluteric dialdehyde.

In some exemplary embodiments, the composite has a dry interlaminar shear strength of at least 50 MPa, or at least 60 MPa, or at least 30 MPa, or at least 50 MPa.

In some exemplary embodiments, the polymer resin material is at least one of polyester resin, vinyl ester resin, phenolic resin, epoxy, polyimide, and styrene.

In some exemplary embodiments, the reinforcement fibers are carbon fibers comprising no greater than about 12,000 filaments, or from about 1,000 to about 12,000 filaments, or from about 2,000 to about 6,000 filaments, or from about 2,000 to about 3,000 filaments.

Further exemplary embodiments of the general inventive concepts are directed to a process for forming a split post-coated carbon fiber bundle. The process includes providing a carbon fiber tow that comprises at least 24,000 filaments coated with a sizing composition; applying a post-coat composition to the at least one carbon fiber tow; and separating the carbon fiber tow into at least one carbon fiber bundle comprising no greater than about 12,000 filaments. The post-coat composition includes about 0.5 to about 5.0 wt. % (including any and all weight percentages between these endpoints) solids of a film former comprising at least one of polyvinylpyrrolidone, polyvinyl acetate, and polyurethane; about 0.05 to about 2.0 wt. % (including any and all weight percentages between these endpoints) solids of a compatibilizer comprising at least one of a silicone-based coupling agent, a titanate coupling agent, a zirconate coupling agent, gluteric dialdehyde, and a quaternary ammonium antistatic agent; and water.

In some exemplary embodiments, the carbon fiber tow comprises at least 50,000 about filaments.

In some exemplary embodiments, the carbon fiber bundle comprises no greater than about 10,000 filaments, or no greater than about 8,000 filaments, or no greater than about 6,000 filaments, or no greater than about 4,000 filaments, or no greater than about 2,000 filaments, or from about 2,000 to about 3,000 filaments.

In some exemplary embodiments, the carbon fiber bundle has a width of between about 0.5 mm to about 4.0 mm.

In some exemplary embodiments, the sizing composition comprises at least one of an epoxy, vinyl ester, and urethane film former.

Further exemplary embodiments of the general inventive concepts are directed to a carbon fiber coated with a composition. The composition comprises about 0.5 to about 5.0 wt. % (including any and all weight percentages between these endpoints) solids of a film former comprising at least one of polyvinylpyrrolidone, polyvinylacetate, and polyurethane; about 0.05 to about 2.0 wt. % (including any and all weight percentages between these endpoints) solids of a compatibilizer comprising silicone-based coupling agent is a mixture of aminopropyltriethoxysilane (A-1100) and at least one of methyl-trimethoxysilane (A-163) and γ-methacryloxypropyltrimethoxysilane (A-174) in a ratio of 1:1 to 3:1; and water. The carbon fiber comprises less than 12,000 filaments.

### DESCRIPTION OF THE DRAWINGS

Various aspects of the general inventive concepts will be more readily understood from the description of certain exemplary embodiments provided below and as illustrated in the accompanying drawings.

FIG. 1 is a side perspective view of an exemplary post-coating application station.

FIG. 2 is a side perspective view of an exemplary arrangement of rollers used to remove excess post-coat composition and dry the fibers.

FIG. 3 is a graph showing the interlaminar shear strength in composites formed with carbon fibers coated with a vinyl ester compatible sizing composition and a post-coating composition having coupling and wetting agents, in comparison to composites formed with carbon fibers coated only with the vinyl ester compatible sizing composition.

FIG. 4 is a graph showing the improvement in carbon wetting and adhesion in vinyl ester sheet molding compound composites with coupling and wetting agents, as compared to vinyl ester sheet molding compound composites made from carbon fibers having only the vinyl ester compatible sizing composition coated thereon.

FIG. 5 is a graph showing the effect that post-coating carbon fibers has on the tensile strength of sheet molding compound samples formed using an unfilled polyester/vinyl ester compound.

FIG. 6 is a graph showing the effect that the bundle size of the carbon fibers has on the tensile strength of sheet molding compound samples.

FIG. 7 is a graph showing the effect that both the bundle size of the carbon fibers and the post-coating applied to the carbon fibers has on the tensile strength of sheet molding compound samples formed using an unfilled polyester/vinyl ester compound.

### DETAILED DESCRIPTION

While the general inventive concepts are susceptible of embodiment in many different forms, there are shown in the drawings and will be described herein in detail specific embodiments thereof with the understanding that the present disclosure is to be considered as an exemplification of the principles of the general inventive concepts. Accordingly, the general inventive concepts are not intended to be limited to the specific embodiments illustrated herein.

Unless otherwise defined, the terms used herein have the same meaning as commonly understood by one of ordinary skill in the art encompassing the general inventive concepts. The terminology used herein is for describing exemplary embodiments of the general inventive concepts only and is not intended to be limiting of the general inventive concepts. As used herein, the singular forms “a,” “an,” and “the” are intended to include the plural forms as well, unless the context clearly indicates otherwise. The term “about” means within +/−10% of a value, or more preferably, within +/−5% of a value, and most preferably within +/−1% of a value. The term “wetting” refers to the ability of the resin to bond to and uniformly spread over the fiber surface. Wetting results from the intermolecular interactions between a liquid and a solid surface. The term “tow” refers to a collection of fiber filaments, which are typically formed simultaneously and optionally coated with a sizing composition. A tow is designated by the number of fiber filaments they contain. For example, a 12 k tow contains about 12,000 filaments.

The present invention relates to methods for improving the downstream processing of reinforcement fibers, such as carbon fibers. Such downstream processes include the production of fiber reinforced composites that comprise a matrix material and reinforcement fibers embedded in the matrix material. The reinforcement fibers function to mechanically enhance the strength and elasticity of the matrix material. The reinforcement fibers may include any type of fiber suitable for providing desirable structural qualities, and in some instances enhanced thermal properties as well, to a resulting composite. Such reinforcing fibers may be organic, inorganic, or natural fibers. In some exemplary embodiments, the reinforcement fibers are made from any one or more of glass, carbon, aramid, polyesters, polyolefins, polyamides, silicon carbide (SiC), boron nitride, and the like. In some exemplary embodiments, the reinforcement fibers include one or more of glass, carbon, and aramid fibers. In some exemplary embodiments, the reinforcement fibers are carbon fibers. It is to be appreciated that although the present application will often refer to the reinforcement fibers as carbon fibers, the reinforcement fibers are not so limited and may alternatively or additionally comprise any of the reinforcement fibers described herein or otherwise known in the art (now or in the future).

Carbon fibers are generally hydrophobic, conductive fibers that have high stiffness, high tensile strength, high temperature tolerance, and low thermal expansion, and are generally light weight, making them popular in forming reinforced composites. However, carbon fibers may be difficult to process in downstream applications, leading to slower and more costly product manufacturing. This is due at least in part to the hydrophobic nature of carbon fibers, which renders them harder to wet than hydrophilic glass fibers in traditional matrices.

Carbon fiber may be turbostratic or graphitic, or have a hybrid structure with both turbostratic and graphitic parts present, depending on the precursor used to make the fiber. In turbostratic carbon fiber, the sheets of carbon atoms are haphazardly folded, or crumpled together. Carbon fibers derived from polyacrylonitrile (PAN) are turbostratic, whereas carbon fibers derived from mesophase pitch are graphitic after heat treatment at temperatures exceeding 2,200° C. In some exemplary embodiments, the carbon fibers are derived from PAN.

Carbon fibers are conductive and have a combination of high tensile strength and high modulus. Consequently, carbon fibers are well suited for producing lightweight composites with desirable mechanical properties when combined with various matrix resins. Depending on the choice of matrix resin, carbon fibers can provide high heat resistance and/pr chemical resistance. This combination of properties has led to the increased use of these materials for weight sensitive applications in industries such as automotive, aerospace, and sporting goods.

Since carbon fiber surfaces are chemically inactive, they are often coated with a sizing composition to form surface functional groups to promote improved chemical bonding and homogenous mixing within a polymer matrix. Homogenous mixing of the fibers or “wetting” within a polymer matrix material is a measure of how well the reinforcement material is encapsulated by the polymer matrix. It is desirable to have the reinforcement fibers completely wet with no dry fibers. Incomplete wetting during this initial processing can adversely affect subsequent processing as well as the surface characteristics of the final composite.

The sizing composition may be applied to the carbon reinforcement fibers during the fiber formation process (e.g., prior to packaging or storing of the formed fibers) in an amount from about 0.5% to about 5% by weight solids of a fiber, or from about 1.0% to about 2.0% by weight solids of the fiber. Alternatively, the carbon fibers may be coated with the sizing composition after the fibers have been formed (e.g., after the fibers have been packaged or stored). In some exemplary embodiments, the sizing composition is an aqueous-based composition, such as a suspension or emulsion. The sizing composition may comprise at least one film former. The film former holds individual filaments together to aid in the formation of the fibers and protect the filaments from damage caused by abrasion including, but not limited to, inter-filament abrasion. Acceptable film formers include, for example, polyvinyl acetates, polyurethanes, modified polyolefins, polyesters, epoxides, and mixtures thereof. The film former also helps to enhance the bonding characteristics of the reinforcement fibers with various resin systems. In some exemplary embodiments, the sizing composition helps to compatibilize the reinforcement fibers with an epoxy, polyurethane, polyester, nylon, phenolic, and/or vinyl ester resin.

Carbon fiber is frequently supplied in the form of a continuous tow wound onto a reel. Each carbon filament in the tow is a continuous cylinder with a diameter of about 5 μm to about 10 μm. The carbon tows come in a wide variety of sizes, from 1 k, 3 k, 6 k, 12 k, 24 k, 50 k, to greater than 50 k, etc. The k value indicates the number of individual carbon filaments within the tow. For instance, a 12 k tow consists of about 12,000 carbon filaments, while a 50 k tow consists of about 50,000 carbon filaments.

The price of a carbon fiber tow generally decreases with increasing filament count, since more material can be processed at a time when manufacturing a large tow compared to smaller tows. To obtain reduced costs by buying carbon in larger supply, it is often desirable to utilize large carbon fiber tow packages, such as 24 k tows, 50 k tows, or larger tows. Additionally larger tows allow for higher production throughput with this lower carbon cost. However, performance in many applications improves with the use of fine tows having a lower filament count, for example 1 k-6 k tows, or from 1 k-3 k tows. Additionally, large tows are generally more difficult to process as it becomes increasingly difficult to wet large carbon tows with a matrix resin.

To obtain such fine tows (e.g., 12 k or smaller), the carbon must either be manufactured as a fine carbon tow or a carbon tow must be split to reduce its filament count. However, as mentioned above, it has been difficult to effectively split a large carbon tow due to fiber breakage and the formation of fuzz, which makes additional processing of the carbon very difficult and costly. Additionally, carbon fibers tend to entangle in a tow package, which makes clean splits without fiber breakage even more challenging. The present inventors have successfully identified a method for splitting and processing carbon fibers that eliminates fiber fuzz and breakage, and also increases dispersibility and adhesion in downstream composites, such as the dispersion and wetting of chopped fiber for sheet molding compounds (“SMC”). Splitting the high carbon tow (e.g., 24 k, 50 k, or larger) into smaller splits (e.g., less than 12 k) can provide better impregnation with resin and better dispersion.

In some exemplary embodiments, the carbon fiber tow is initially spread to disassociate individual carbon filaments and begin to create a plurality of thinner bundles. The spread carbon fibers may then be pulled under tension to maintain consistent spreading and to further increase the spread between the fibers. For example, a plurality of carbon fibers having widths of about ⅜″ to about ½″ may be pulled along a variety of rollers under tension to form spreads between about ¾″ to about 1½ ″. The angles and radius of the rollers should be set to maintain a tension that is not too high, which could pull the spread fibers back together.

It has been unexpectedly discovered that the application of a secondary composition or “post-coat” composition to spread carbon fibers facilitates the splitting of these large carbon fiber tows into any number of smaller carbon fiber bundles each having no greater than 12 k filaments.

This secondary or “post-coat” composition overcomes various known obstacles typically encountered when attempting to split carbon fiber tows into smaller carbon fiber bundles and additionally improves the properties of the carbon fibers and any reinforced composites formed using such post-coated fibers. As used herein, a “post-coat” composition refers to a composition applied to a reinforcement fiber as a secondary coating, after the fiber has been previously coated with a sizing composition and that sizing composition has been fully dried. Alternatively, the post-coat composition may be applied to a reinforcement fiber that has not been previously coated with a sizing composition. Particularly, referring specifically to carbon fibers, the post-coat composition improves the ability to split a carbon fiber tow by reducing the development of fuzz, fiber breakage, and/or fiber fraying; the ability to chop carbon fibers by improving strand cohesion; and the wetting of carbon fibers in a resin matrix, over otherwise identical carbon fibers that are only coated with the sizing composition.

The post-coat composition is an aqueous composition that comprises about 2.5 to about 5.0 wt. % solids, or from about 3.0 to about 4.5 wt. % solids, or from about 3.5 to about 4.0 wt. % solids, based on the total solids content of the aqueous composition. Once applied to the fibers, the post-coat composition has a solids content of about 0.1 to about 3.0 wt. %, or in an amount from about 0.5 to about 2.0 wt. % active strand solids, or from about 0.5 to about 1.0 wt. % active stand solids.

In some exemplary embodiments, the post-coat composition comprises at least one film former. For example, the post-coat composition may comprise one or more of polyvinylpyrrolidone (PVP), polyvinylacetate (PVA), and polyurethane (PU) as a film forming agent.

Polyvinylpyrrolidone exists in several molecular weight grades characterized by K-value. For example and not by way of limitation, PVP K-12 has a molecular weight of about 4,000 to about 6,000; PVP K-15 has a molecular weight of about 6,000 to about 15,000; PVP K-30 has a molecular weight of about 40,000 to about 80,000; and PVP K-90 has a molecular weight of about 1,000,000 to about 1,700,000. In some exemplary embodiments, the film former comprises PVP K-90. PVP promotes dispersency of the fibers in a matrix for more uniform distribution, as well as hydrophilicity for water solubility and adhesion. PVP also may act as an encapsulant to the fibers and additionally to lubricants, such as oil, present in an aqueous dispersant.

The film former may be present in the post-coat composition in an amount from about 0.5 to about 5.0 wt. %, or from about 1.0 to about 4.75 wt. %, or from about 3.0 to about 4.0 wt. %, based on the total weight of the aqueous composition. This measurement is based on the weight percent of film former solids divided by the total weight of the solution. Once applied to the fiber strands, the film former may be present in an amount from about 0.1 to about 2.0 wt. % by strand solids, or about 0.3 to about 0.6 by wt. % by strand solids.

In some exemplary embodiments, the post-coat composition additionally includes a compatibilizer. A compatibilizer may provide a variety of functions synergystically between the film former, the reinforcement (e.g., carbon) fiber, and a resin interface. In some exemplary embodiments, the compatibilizer comprises a coupling agent, such as a silicone-based coupling agent (e.g., silane coupling agents), a titanate coupling agent, or a zirconate coupling agent. Silane coupling agents are conventionally used in sizing compositions for inorganic substrates having hydroxyl groups than can react with the silanol-containing reactive groups. However, alkali metal oxides and carbonates do not form stable bonds with Si—O. Therefore, although such coupling agents have been traditionally used in sizing compositions for glass fibers, it has been surprisingly discovered that utilizing such coupling agents in the present post-coat composition does in fact function to enhance the adhesion of the film forming polymers to the non-glass (i.e., carbon) fibers and reduce the level of fuzz, or broken fiber filaments, during subsequent processing and splitting. Examples of silane coupling agents, which may be suitable for use in the post-coating composition, include those characterized by the functional groups acryl, alkyl, amino, epoxy, vinyl, azido, ureido, and isocyanato.

Suitable silane coupling agents for use in the post-coat composition include, but are not limited to, γ-aminopropyltriethoxysilane (A-1100), n-trimethoxy-silyl-propyl-ethylene-diamine (A-1120), γ-methacryloxypropyltrimethoxysilane (A-174), γ-glycidoxypropyltrimethoxysilane (A-187), methyl-trichlorosilane (A-154), methyl-trimethoxysilane (A-163), γ-mercaptopropyl-trimethoxy-silane: (A-189), bis-(3-[triethoxysilyl]propyl)tetrasulfane (A-1289), γ-chloropropyl-trimethoxy-silane (A-143), vinyl-triethoxy-silane (A-151), vinyl-tris-(2-methoxyethoxy)silane (A-172), vinylmethyldimethoxysilane (A-2171), vinyl-triacetoxy silane (A-188), octyltriethoxysilane (A-137), and methyltriethoxysilane (A-162).

In some exemplary embodiments, the compatibilizer comprises a mixture of two or more silane coupling agents. For instance, the compatibilizer may include a mixture of aminopropyltriethoxysilane (A-1100) and one or more of methyl-trimethoxysilane (A-163) and γ-methacryloxypropyltrimethoxysilane (A-174). In some instances, the compatibilizer includes A-1100 and A-163 in a ratio of about 1:1 to about 3:1. In some instances, the compatibilizer includes A-1100 and A-174 in a ratio of about 1:1 to about 3:1.

In some exemplary embodiments, the compatibilizer comprises an organic dialdehyde. Exemplary dialdehydes include gluteric dialdehyde, glycoxal, malondialdehyde, succidialdehyde, phthaladldehyde, and the like. In some exemplary embodiments, the organic dialdehyde is gluteric dialdehyde.

In some exemplary embodiments, the compatibilizer comprises one or more antistatic agents, such as a quaternary ammonium antistatic agent. The quaternary ammonium antistatic agent may comprise triethylalkyletherammonium sulfate, which is a trialkylalkyetherammonium salt with trialkyl groups, 1-3 carbon atoms, alkylether group with alkyl group of 4-18 carbon atoms, and ether group of either ethylene oxide or propylene oxide. An example of a triethylalkyletherammonium sulfate is EMERSTAT 6660A.

The compatibilizer may be present in the post-coat composition in an amount from about 0.05 wt. % to about 5.0 wt. % active solids, or in an amount from about 0.1 wt. % to about 1.0 wt. % active solids, or from about 0.2 wt. % to about 0.7 wt. % active solids. In some exemplary embodiments, the compatibilizer is present in the post-coat composition in an amount from about 0.3 wt. % to about 0.6 wt. % active solids. This measurement is based on the weight percent of compatibilizer solids divided by the total weight of the solution.

In some exemplary embodiments, the post-coat composition has a pH of less than about 10. In some exemplary embodiments, the post-coat composition has a pH between about 3 and about 7, or between about 4 and about 6, or between about 4.5 and about 5.5.

Table 1 illustrates some exemplary post-coating compositions according to the general inventive concepts.

TABLE 1

| | PVP | Compatibilizer | Silane and ratio (if | Additional Additive | |
|---|---|---|---|---|---|
| | (wt %) | (wt %) | applicable) | (wt %) | Final Ph |
| Sample 1 | 3.5 | 0.5 | A-163 | | 4.5 |
| Sample 2 | 3.5 | — | — | Emerstat 6660A | 5.5 |
| | | | | (0.2) | |
| Sample 3 | 3.5 | 0 | — | — | |
| Sample 4 | 3.5 | 0.5 | A-163/1100 (75/25) | — | 4.5 |
| Sample 5 | 3.5 | 0.5 | A-163/1100 (50/50) | — | 4.5 |
| Sample 6 | 3.5 | 0.5 | A-174 | Emerstat 6660A | 4.7 |
| | | | | (0.2%) | |
| Sample 7 | 3.5 | 0.5 | A-174/1100 (75/25) | — | 4.5 |
| Sample 8 | 3.5 | 0.5 | A-1100 | — | 9 |
| Sample 9 | 3.5 | 0.5 | A-174/1100 (50/50) | — | 5 |
| Sample 10 | 3.5 | 0.5 | 174 | — | 4 |
| Sample 11 | 3 | 0.5 | A-174/1100 (50/50) | — | 4.5 |
| Sample 12 | 3.5 | — | — | Gluteric dialdehyde | 5 |
| | | | | (0.5%) | |
| Sample 13 | 3.5 | — | — | Gluteric dialdehyde | 4.5 |
| | | | | (0.2%) | |
| Sample 14 | 3 | 0.5 | A-163/1100 (50/50) | — | 4.5 |
| Sample 15 | 0 | 0 | No post-coating | — | NA |

The post-coating composition may be applied to one or more carbon fiber tows at any time after the carbon fibers have been formed, coated with a sizing composition (if a sizing composition is applied), and dried.

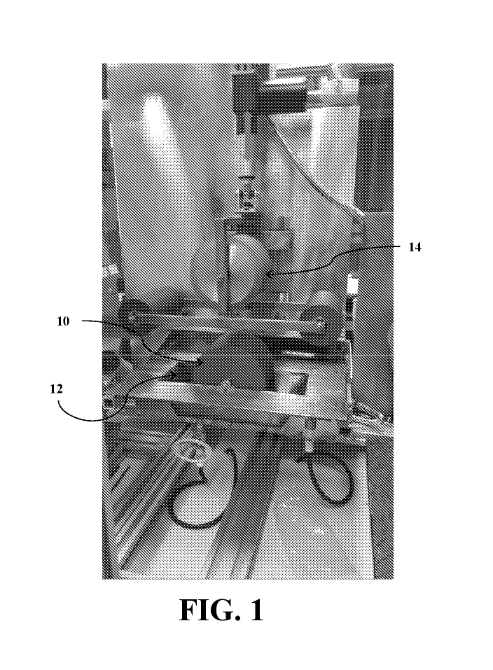

In some exemplary embodiments, the post-coat composition may be applied using one or more coating rollers and/or coating applicators that pull the tow through a post-coat bath 12 under managed tension, as illustrated in FIG. 1. In some exemplary embodiments, the post-coat application rollers include a first coating roller 14, which may be a combed, convoluted, or grooved roller, and a motorized coating applicator roller 10 submerged in a dip bath 12. The motorized coating applicator roller 10 may rotate at about 70 rpm to about 120 rpm, or at about 90 rpm to about 100 rpm, which pulls the tow through the dip bath 12 to apply the post-coating composition to the tow. The first coating roller may raise and lower to sandwich the carbon fiber tow between the first coating roller 14 and the coating application roller 10 to remove any excess post-coat composition and help to control the thickness of the coated tow.

In some exemplary embodiments, rather than pulling the tow through a post-coat dip tank, the post-coat composition may be applied to the tow by any other suitable coating method, such as a kiss-coating method. As another example, the post-coat composition may be sprayed on the fiber tow by one or more spraying devices or applied to the tow using one or more applicator rolls.

In some exemplary embodiments, the post-coated carbon fiber tow may then be split into a plurality of thinner carbon fiber bundles, each comprising no greater than about 12,000 (12 k) carbon filaments. In some exemplary embodiments, the carbon fiber bundles comprise less than about 10,000 carbon filaments, or less than about 9,000 carbon filaments, or less than about 8,000 carbon filaments, or less than about 7,000 carbon filaments, or less than about 6,000 carbon filaments, or less than about 5,000 carbon filaments, or less than about 4,000 carbon filaments, or less than about 3,000 carbon filaments, or less than about 2,000 carbon filaments, or less than about 1,000 carbon filaments. In some exemplary embodiments, the carbon fiber tow comprises from about 1,000 to 12,000 carbon filaments, or from about 2,000 to 6,000 carbon filaments, or from about 2,000 to about 3,000 carbon filaments. The carbon fiber bundles have a diameter of about 0.5 mm to about 4.0 mm, or about 1.0 mm to about 3.0 mm.

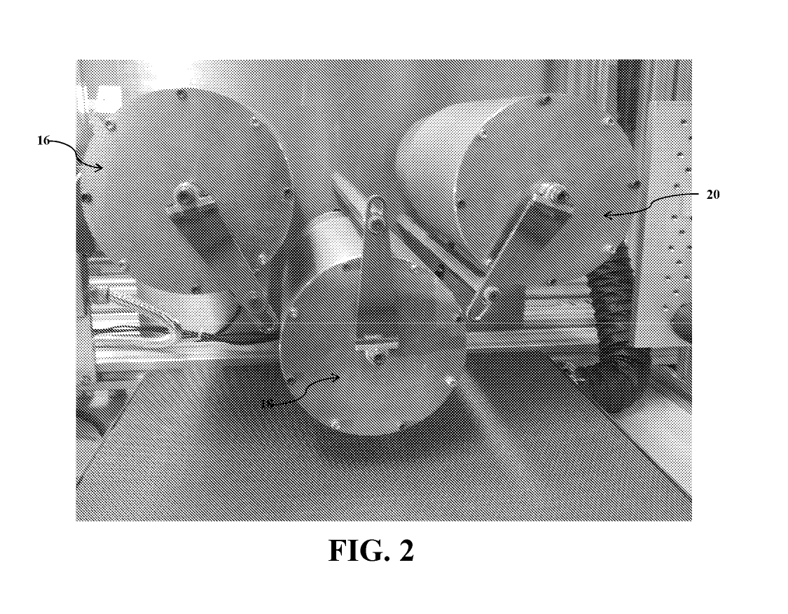

The coated carbon fibers may be pulled over a combination of rollers 16, 18, 20 to remove excess post-coat composition and to at least partially dry the fibers, as illustrated in FIG. 2. Any combination of rollers 16, 18, 20 may be motorized and/or heated to begin to dry or fully dry the coated fibers and to coalesce the post-coat composition into a film on the fibers prior to introduction into a drying oven, if needed.

In some exemplary embodiments, the coated carbon fibers are pulled through a dryer, such as an oven, to dry the post-coat composition on the carbon fiber tow. The dryer removes the excess water from the coated fibers without also removing the functional solids. In some exemplary embodiments, the oven is an infrared or convection oven. The oven may be a non-contact oven, meaning that the carbon fiber tow is pulled through the oven without being contacted by any part of the oven. The oven temperature may be any temperature suitable for properly drying the post-coat composition on the carbon fibers. In some exemplary embodiments, the oven temperature is about 230° F. to about 600° F., or from about 300° F. to about 500° F.

Once dried, the coated fiber tow may then be wound by a winder to produce a coated fiber package, or the fibers may be immediately utilized in a downstream process, such as for compounding with a thermoplastic composition in a long fiber thermoplastic compression molding process, or chopped for use in a compounding process, such as SMC. In some exemplary embodiments, the coated fiber tow is utilized to produce a hybrid assembled roving, as described in U.S. provisional patent application Ser. No. 62/061,323, the disclosure of which is incorporated herein by reference.

In the formation of fiber reinforced composites, prepregs, fabrics, nonwovens, and the like, the polymer resin matrix material may comprise any suitable thermoplastic or thermosetting material, such as polyester resin, vinyl ester resin, phenolic resin, epoxy, polyimide, and/or styrene, and any desired additives such as fillers, pigments, UV stabilizers, catalysts, initiators, inhibitors, mold release agents, viscosity modifiers, and the like. In some exemplary embodiments, the thermosetting material comprises a styrene resin, an unsaturated polyester resin, or a vinyl ester resin. In structural SMC applications, the polymer resin film may comprise a liquid, while in Class A SMC applications, the polymer resin matrix may comprise a paste.

It has been discovered that applying a post-coat composition to the carbon tow, not only facilitates the splitting of the carbon tow (e.g., by reducing the formation of fuzz and filament breakage), but also improves the dispersibility, flowability, and adhesion of the fibers relative to a matrix material in downstream processing. When carbon fibers are chopped for downstream processing, the formation of fuzz works against dispersion of the chopped fibers in a matrix material. Accordingly, by applying the post-coating composition, the formation of fuzz is reduced, which improves fiber dispersion.

In addition to improving the processability of the carbon fiber tow, the post-coating composition also compatibilizes the carbon fibers with a polymer resin matrix material for composite production. Compatibilizing the carbon fibers with the matrix material allows the carbon fibers to flow and wet properly, forming a substantially homogenous dispersion of carbon fibers within the polymer matrix material. The post-coat composition also imparts increased cohesion, which allows for improved chopping of the fibers and improved wetting in the consolidation process.

Additionally, the coated fibers disclosed herein demonstrate at least a 10% increase in tensile strength over fibers that were not coated with the post-coating composition. In some exemplary embodiments, the coated fibers demonstrated at least a 15% increase in tensile strength and in some embodiments an increase of at least 20% in tensile strength.

Having generally described various aspects of the general inventive concepts, a further understanding can be obtained by reference to certain specific examples illustrated below. These examples are provided for purposes of illustration only and are not intended to be limiting unless otherwise specified.

### Examples

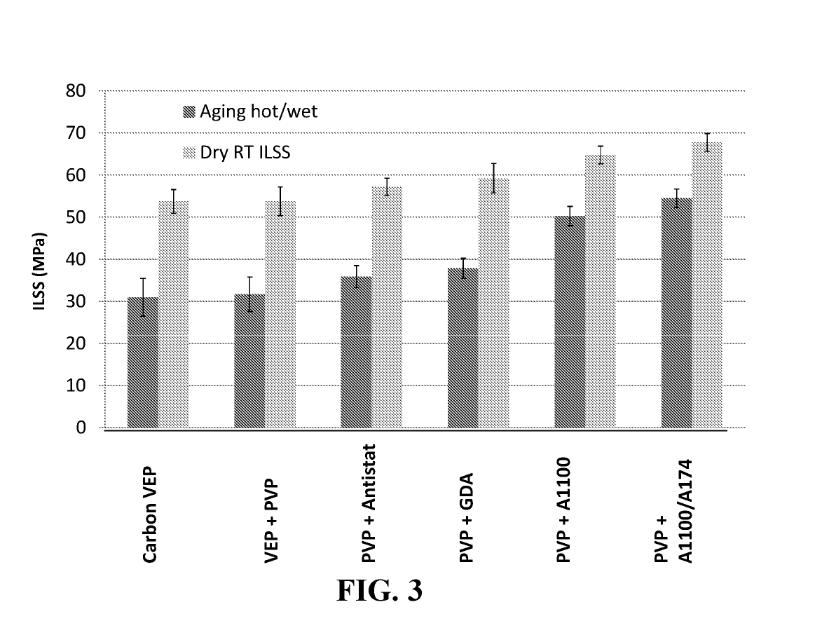

FIG. 3 demonstrates improved chop dispersion (dry inter-laminar shear strength (“ILSS”)) and matrix adhesion (aging hot/wet ILSS) in chopped carbon fibers that have been coated with exemplary post-coating compositions in the production of sheet molding compounds (“SMC”). FIG. 3 illustrates the improvement in ILSS of carbon fiber reinforced SMC material comprising 60%+/−2% carbon fibers coated with a vinyl ester compatible sizing composition and a post-coat composition. The ILSS of a composite is determined primarily by the interfacial bonding between the reinforcing fiber and the matrix material. As shown in FIG. 3, vinyl ester composites formed with sized carbon fibers coated with the post-coating composition, including 3.5 to 4.0 weight % solids PVP in addition to at least one of a silane, an antistat agent, and gluteric dialdehyde, exhibited an improvement in dry ILSS of up to 25% and an improvement in aging hot/wet resistance of up to 70% compared to carbon fibers coated only with a vinyl ester-compatible sizing composition. In particular, vinyl ester composites formed using sized carbon fibers coated with PVP and at least one of an antistatic agent, gluteric dialdehyde, and at least one silane coupling agent demonstrated an interlaminar shear strength of greater than 55 MPa, and in some exemplary embodiments of greater than 60 MPa. Similarly, the same composites also demonstrated an improvement in aging hot/wet performance, with interlaminar shear strengths of at least 35 MPa, and in some exemplary embodiments of at least 50 MPa.

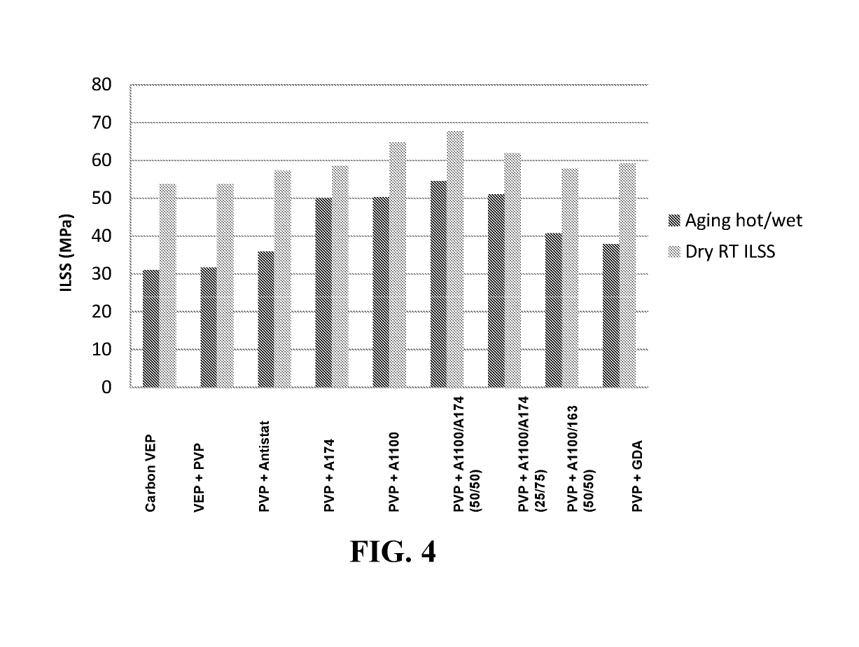

FIG. 4 further illustrates the improved ILSS (both dry and aging hot/wet) achieved in carbon reinforced vinyl ester composites prepared using vinyl ester-compatible sized carbon fibers that have been coated with 3.5 to 4.0 weight % solids PVP and one or more compatibilizer. The post-coat composition, when applied, accounts for about 0.2 to about 1.0 weight % solids of the coated carbon fiber. As illustrated in FIG. 4, each carbon reinforced composite that incorporated coated carbon reinforcement fibers achieved a dry ILSS of at least 55 MPa and an aged hot/wet ILSS of at least 35 MPa, with the composites that include carbon fibers coated with a PVP+γ-aminopropyltriethoxysilane either independently or in combination with γ-methacryloxypropyltrimethoxysilane achieving a dry ILSS of at least 60 MPa and an aged hot/wet ILSS of at least 50 MPa.

Tables 2 and 3 illustrate a comparison of vinyl ester composites formed using carbon fibers coated with one of the post-coat samples listed therein. Table 2 includes carbon-reinforced composites formed with carbon fibers sized with an epoxy compatible sizing. Table 3 includes carbon-reinforced composites formed with carbon fibers sized with a vinyl ester compatible sizing. Tables 2 and 3 reflect the composite's wetting properties (dry ILSS) and adhesion properties through aged ILSS (hot/wet 72 hour boil).

TABLE 2

| | | Dry ILSS | Aged ILSS |
|---|---|---|---|
| Sample | Composition | (MPa) | (MPa) |
| 1 | 3.5 wt % PVP with 0.5 wt % (50% A-163/50% A- | 44 | 29 |
| | 1100) | | |
| 2 | 3.5 wt % PVP with 0.2/0.2/0.2% of gluteric | 53 | 32 |
| | dialdehyde/A-174/A-1100 | | |
| 3 | 3.5 wt % PVP with 0.5 wt % (50% A-163/50% A- | 53 | 28 |
| | 1100) | | |
| 4 | 3.5 wt % PVP with 0.5 wt % A-174 and 0.2% | 53 | 33 |
| | Emerstat ™ 66660A | | |
| 5 | 3.5 wt % PVP with 0.5 wt % (75% A-174/25% A- | 47 | 34 |
| | 1100) | | |
| 6 | 3.5 wt % PVP with 0.2 wt % gluteric dialdehyde | 51 | 31 |
| 7 | 3.5 wt % PVP with 0.5 wt % (50% A-174/50% A- | 46 | 32 |
| | 1100) | | |
| 8 | No Post-coat | 55 | 26 |

As illustrated in Table 2, reinforced vinyl ester composites formed with carbon fibers (epoxy compatible sizing) that have been post-coated according to the present inventive concepts demonstrate improved adhesion properties, compared to otherwise identical composite formed with carbon fibers that were not been post-coated. For example, Sample 5 demonstrated an aged interlaminar shear strength of 34 MPa, compared to comparative Sample 8 having an aged interlaminar shear strength of 26 MPa.

TABLE 3

| | | Dry ILSS | Aged ILSS |
|---|---|---|---|
| Sample | Composition | (MPa) | (MPa) |
| 9 | 3.5 wt % PVP with 0.5 wt % (75% A-163/25% A- | 58 | 42 |
| | 1100) | | |
| 10 | 3.5 wt % PVP with 0.5 wt % (50% 163/50% A- | 54 | 38 |
| | 1100) | | |
| 11 | 3.5 wt % PVP with 0.5 wt % (75% A-174/25% A- | 62 | 52 |
| | 1100) | | |
| 12 | 3.5 wt % PVP with 0.5 wt % A-1100 | 65 | 55 |
| 13 | 3.5 wt % PVP with 0.5 wt % (50% A-174/50% A- | 66 | 56 |
| | 1100) | | |
| 14 | 3.5 wt % PVP with 0.5 wt % A-174 | 60 | 50 |
| 15 | 3.0 wt % PVP with 0.5 wt % (50% A-174/50% A- | 58 | 38 |
| | 1100) | | |
| 16 | 3.5 wt % PVP with 0.5 wt % gluteric dialdehyde | 60 | 32 |
| 17 | 3.5 wt % PVP with 0.2% of gluteric dialdehyde | 54 | 38 |
| 18 | No post-coat | 54 | 31 |

As illustrated in Table 3, reinforced vinyl ester composites formed with carbon fibers (vinyl ester compatible sizing) that have been post-coated according to the present inventive concepts demonstrate improved wetting and adhesion properties, compared to otherwise identical composite formed with carbon fibers that were not been post-coated. For example, Samples 9, and 11-16 demonstrate a dry interlaminar shear strength of at least 55 MPa and Samples 9-15 and 17 demonstrate an aged hot/wet interlaminar shear strength of at least 35 MPa, both of which are significant improvements over Sample 18, which was formed using carbon fibers without a post-coat.

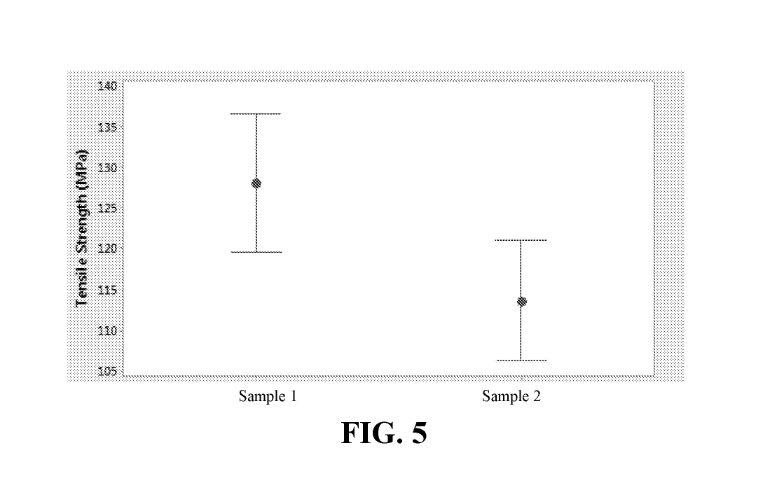

FIG. 5 illustrates a comparison between two SMC samples formed using an unfilled polyester/vinyl ester compound. Each sample included 35 wt. % carbon fiber and 65 wt. % glass fiber. The carbon fibers utilized in Sample 1 were formed from a 50 k tow that was post-coated and split into 1 k to 6 k carbon fiber bundles. The post-coat composition comprised 3.5 wt. % of a PVP film former with 0.5 wt. % of a compatibilizer mixture of 75% A-174/25% A-1100. The carbon fibers utilized in Sample 2 included a 50 k unmodified fiber tow (no post-coating or splitting). The samples were otherwise consistent and were formed using the same processing conditions. The composites were molded into flat plates and tested via ISO-527-4. As illustrated in FIG. 5, Sample 1 demonstrated an increased tensile strength of about 128 MPa, while Sample 2 demonstrated a tensile strength of about 113 MPa, which is a statistically significant improvement of about 13%.

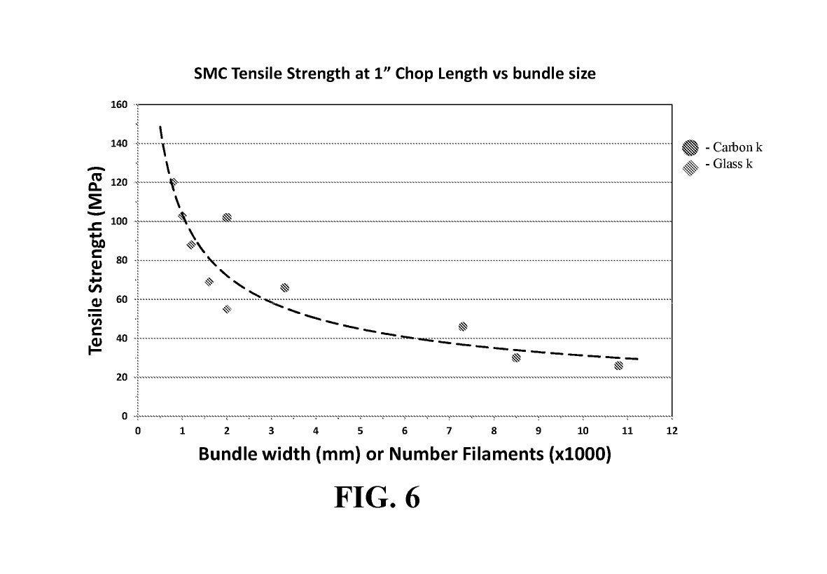

Additionally, it is clear from FIG. 6 that the size of the split carbon fiber bundles further impacts the tensile strength of a polyester/vinyl ester SMC composite article. Particularly, the tensile strength of the composite was relatively level when including bundle sizes above about 7 k (between about 30 to 40 MPa). However, when including carbon fiber bundles of 6 k or less, the tensile strength of the composite increased exponentially from about 40 MPa to about 150 MPa and above, with the highest tensile strength being demonstrated in a composite formed using less than 1 k carbon fiber bundles.

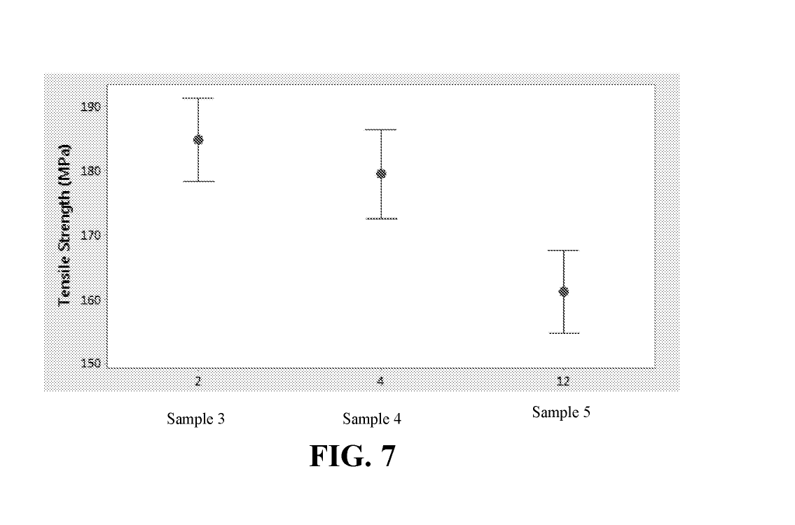

FIG. 7 demonstrates the impact that the combination of both the post-coat composition and the size of the carbon fiber splits has on the tensile strength of unfilled polyester/vinyl ester SMC composites. Each sample was formed using 35 wt. % carbon fiber and 65 wt. % glass fiber. The carbon fibers utilized in Samples 3 and 4 were formed from a 24 k post-coated carbon tow (2 k and 4 k bundles, respectively). The post-coat composition comprised 3.5 wt. % a PVP film former with 0.5 wt. % a compatibilizer mixture of 75% A-174/25% A-1100. Sample 5 was formed using a 12 k uncoated carbon fiber tow. The Samples were otherwise consistent and were formed using the same processing conditions. The composites were molded into flat plates and tested via ISO-527-4. As illustrated in FIG. 7, Sample 5 demonstrated the lowest tensile strength of about 160 MPa, while both Samples 3 and 4, including post-coated and split carbon fiber bundles, demonstrated increased tensile strengths of at least 180 MPa. Moreover, Sample 3, having the smallest carbon fiber bundles (2 k), demonstrated the highest tensile strength of about 185 MPa, which indicates that it is both the size of the carbon fiber bundles and the presence of the post-coat composition that improves the composite tensile strength.

Although various exemplary embodiments have been described and suggested herein, it should be appreciated that many modifications can be made without departing from the spirit and scope of the general inventive concepts. All such modifications are intended to be included within the scope of the invention, which is to be limited only by the following claims.

All references to singular characteristics or limitations of the present disclosure shall include the corresponding plural characteristic or limitation, and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

The methods may comprise, consist of, or consist essentially of the process steps described herein, as well as any additional or optional process steps described herein or otherwise useful.

In some embodiments, it may be possible to utilize the various inventive concepts in combination with one another (e.g., one or more of the first, second, etc., exemplary embodiments may be utilized in combination with each other). Additionally, any particular element recited as relating to a particularly disclosed embodiment should be interpreted as available for use with all disclosed embodiments, unless incorporation of the particular element would be contradictory to the express terms of the embodiment. Additional advantages and modifications will be readily apparent to those skilled in the art. Therefore, the disclosure, in its broader aspects, is not limited to the specific details presented therein, the representative apparatus, or the illustrative examples shown and described. Accordingly, departures may be made from such details without departing from the spirit or scope of the general inventive concepts.

1. A composition for coating a fiber, the composition comprising:
about 0.5 to about 5.0 wt. % solids of a film former, said film former comprising at least one of polyvinylpyrrolidone, polyvinylacetate, and polyurethane; and
about 0.05 to about 2.0 wt. % solids of a compatibilizer, said compatibilizer comprising at least one of a silicone-based coupling agent, a titanate coupling agent, a zirconate coupling agent, organic dialdehyde, and a quaternary ammonium antistatic agent; and
water.

2. The composition of claim 1, wherein said fiber comprises at least one of glass, carbon, aramid, polyesters, polyolefins, polyamides, silicon carbide (SiC), and boron nitride fibers.

3. The composition of claim 2, wherein said fiber is a carbon fiber bundle comprising no greater than 12,000 filaments.

4. The composition of claim 2, wherein said fiber is a carbon fiber bundle comprising between about 1,000 and about 6,000 filaments.

5. (canceled)

6. The composition of claim 1, wherein said film former consists of polyvinylpyrrolidone.

7. The composition of claim 6, wherein said polyvinylpyrrolidone has a molecular weight of 1,000,000 to 1,700,000.

8. The composition of claim 1, wherein said silicone-based coupling agent comprises at least one of γ-aminopropyltriethoxysilane (A-1100), n-trimethoxy-silyl-propyl-ethylene-diamine (A-1120), γ-methacryloxypropyltrimethoxysilane (A-174), γ-glycidoxypropyltrimethoxysilane (A-187), methyl-trichlorosilane (A-154), methyl-trimethoxysilane (A-163), γ-mercaptopropyl-trimethoxy-silane: (A-189), bis-(3-[triethoxysilyl]propyl)tetrasulfane (A-1289), γ-chloropropyl-trimethoxy-silane (A-143), vinyl-triethoxy-silane (A-151), vinyl-tris-(2-methoxyethoxy)silane (A-172), vinylmethyldimethoxysilane (A-2171), vinyl-triacetoxy silane (A-188), octyltriethoxysilane (A-137), and methyltriethoxysilane (A-162).

9. The composition of claim 1, wherein said silicone-based coupling agent is a mixture of aminopropyltriethoxysilane (A-1100) and at least one of methyl-trimethoxysilane (A-163) and γ-methacryloxypropyltrimethoxysilane (A-174).

10. The composition of claim 1, wherein said silicone-based coupling agent comprises aminopropyltriethoxysilane (A-1100) and methyl-trimethoxysilane (A-163) in a ratio of 1:1 to 3:1.

11. The composition of claim 1, wherein said silicone-based coupling agent comprises aminopropyltriethoxysilane (A-1100) and γ-methacryloxypropyltrimethoxysilane (A-174) in a ratio of 1:1 to 3:1.

12. The composition of claim 1, wherein said film former comprises polyvinylpyrrolidone and wherein said compatibilizer comprises aminopropyltriethoxysilane (A-1100) and methyl-trimethoxysilane (A-163) in a ratio of 1:1 to 3:1 and triethylalkyletherammonium sulfate.

13. The composition of claim 1, wherein said film former comprises polyvinylpyrrolidone and wherein said compatibilizer comprises aminopropyltriethoxysilane (A-1100) and γ-methacryloxypropyltrimethoxysilane (A-174) in a ratio of 1:1 to 3:1 and triethylalkyletherammonium sulfate.

14. A composition for coating a fiber, the composition consisting essentially of:
a film former, said film former comprising at least one of polyvinylpyrrolidone, polyvinylacetate, and polyurethane;
a compatibilizer, said compatibilizer comprising at least one of a silicone-based coupling agent, a titanate coupling agent, a zirconate coupling agent, gluteric dialdehyde, and a quaternary ammonium antistatic agent; and
water.

15-18. (canceled)

19. A process for compatibilizing a plurality of reinforcement fibers with a polymer matrix material, the process comprising:
coating said reinforcement fibers with a coating composition comprising:
about 0.5 to about 5.0 wt. % solids of a film former, said film former comprising at least one of polyvinylpyrrolidone, polyvinylacetate, and polyurethane;
about 0.05 to about 2.0 wt. % solids of a compatibilizer, said compatibilizer comprising at least one of a silicone-based coupling agent, a titanate coupling agent, a zirconate coupling agent, organic dialdehyde, and a quaternary ammonium antistatic agent; and
water.

20. The process of claim 19, wherein said reinforcement fibers comprise at least one of glass, carbon, aramid, polyesters, polyolefins, polyamides, silicon carbide (SiC), and boron nitride fibers.

21. The process of claim 19, wherein said reinforcement fibers are carbon fibers.

22. The process of claim 19, wherein prior to coating said reinforcement fibers with said coating composition, said reinforcement fibers are coated with a sizing composition and said sizing composition is dried.

23. The process of claim 22, wherein said sizing composition comprises at least one of an epoxy, vinyl ester, and urethane film former.

24. The process of claim 19, wherein said film former comprises polyvinylpyrrolidone.

25. (canceled)

26. The process of claim 19, wherein said silicone-based coupling agent is a mixture of aminopropyltriethoxysilane (A-1100) and at least one of methyl-trimethoxysilane (A-163) and γ-methacryloxypropyltrimethoxysilane (A-174).

27. The process of claim 19, wherein said silicone-based coupling agent comprises aminopropyltriethoxysilane (A-1100) and methyl-trimethoxysilane (A-163) in a ratio of 1:1 to 3:1.

28. The process of claim 19, wherein said silicone-based coupling agent comprises aminopropyltriethoxysilane (A-1100) and γ-methacryloxypropyltrimethoxysilane (A-174) in a ratio of 1:1 to 3:1.

29. The process of claim 19, wherein said quaternary ammonium antistatic agent comprises triethylalkyletherammonium sulfate.

30. The process of claim 19, wherein said organic dialdehyde comprises one or more of gluteric dialdehyde, glycoxal, malondialdehyde, succidialdehyde, and phthaladldehyde.

31. (canceled)

32. A carbon fiber coated with a composition comprising:
about 0.5 to about 5.0 wt. % solids of a film former, said film former comprising at least one of polyvinylpyrrolidone, polyvinylacetate, and polyurethane;
about 0.05 to about 2.0 wt. % solids of a compatibilizer, said compatibilizer comprising at least one of a silicone-based coupling agent, a titanate coupling agent, a zirconate coupling agent, gluteric dialdehyde, and a quaternary ammonium antistatic agent; and
water,
wherein said carbon fiber comprises less than about 12,000 filaments.

33-37. (canceled)

38. The carbon fiber of claim 32, wherein said carbon fiber comprises about 2,000 to about 3,000 filaments.

39. The carbon fiber of claim 32, wherein said carbon fiber has a width of between about 0.5 mm to about 4.0 mm.

40. The carbon fiber of claim 32, wherein said carbon fiber is a carbon has been coated with a sizing composition comprising at least one of an epoxy, vinyl ester, and urethane film former.

41. A fiber-reinforced composite comprising:
a plurality of reinforcement fibers having a coating thereon, said coating comprising:
about 0.5 to about 5.0 wt. % solids of a film former, said film former comprising at least one of polyvinylpyrrolidone, polyvinylacetate, and polyurethane;
about 0.05 to about 2.0 wt. % solids of a compatibilizer, said compatibilizer comprising at least one of a silicone-based coupling agent, a titanate coupling agent, a zirconate coupling agent, organic dialdehyde, and a quaternary ammonium antistatic agent; and
water; and
a polymer resin material.

42-45. (canceled)

46. The fiber-reinforced composite of claim 41, wherein said silicone-based coupling agent is a mixture of aminopropyltriethoxysilane (A-1100) and at least one of methyl-trimethoxysilane (A-163) and γ-methacryloxypropyltrimethoxysilane (A-174).

47. The fiber-reinforced composite of claim 41, wherein said silicone-based coupling agent comprises aminopropyltriethoxysilane (A-1100) and methyl-trimethoxysilane (A-163) in a ratio of 1:1 to 3:1.

48. The fiber-reinforced composite of claim 4, wherein said silicone-based coupling agent comprises aminopropyltriethoxysilane (A-1100) and γ-methacryloxypropyltrimethoxysilane (A-174) in a ratio of 1:1 to 3:1.

49. The fiber-reinforced composite of claim 41, wherein said quaternary ammonium antistatic agent comprises triethylalkyletherammonium sulfate.

50. The fiber-reinforced composite of claim 41, wherein said organic dialdehyde comprises one or more of gluteric dialdehyde, glycoxal, malondialdehyde, succidialdehyde, and phthaladldehyde.

51. The fiber-reinforced composite of claim 50, wherein said organic dialdehyde comprises gluteric dialdehyde.

52. The fiber-reinforced composite of claim 41, wherein said composite has a dry interlaminar shear strength of at least 50 MPa.

53-56. (canceled)

57. The fiber-reinforced composite of claim 41, wherein said reinforcement fibers are carbon fibers comprising no greater than about 12,000 filaments.

58-60. (canceled)

61. A process for forming a split post-coated carbon fiber bundle, said process comprising:
providing a carbon fiber tow, wherein said carbon fiber tow comprises at least 24,000 filaments coated with a sizing composition;
applying a post-coat composition to said at least one carbon fiber tow; and
separating the carbon fiber tow into at least one carbon fiber bundle comprising no greater than about 12,000 filaments, wherein said post-coat composition comprises:
about 0.5 to about 5.0 wt. % solids of a film former, said film former comprising at least one of polyvinylpyrrolidone, polyvinyl acetate, and polyurethane;
about 0.05 to about 2.0 wt. % solids of a compatibilizer, said compatibilizer comprising at least one of a silicone-based coupling agent, a titanate coupling agent, a zirconate coupling agent, gluteric dialdehyde, and a quaternary ammonium antistatic agent; and
water.

62. The process of claim 61, wherein said carbon fiber tow comprises at least 50,000 about filaments.

63. The process of claim 61, wherein said carbon fiber bundle comprises no greater than about 10,000 filaments.

64-71. (canceled)
